(19) United States
(12) Patent Application Publication
(10) Pub. No.: US 2002/0049922 A1
(43) Pub. Date: Apr. 25, 2002

(54) Search engine system and method

(75) Inventor: Harry George Direen JR., Colorado Springs, CO (US)

Correspondence Address: Law Offices of Dale B. Halling, Suite 311, 24 South, Weber St., Colorado Springs, CO, 80903, US

(73) Assignee: NeoCore Inc.

(21) Appl. No.: 09/973,491

(22) Filed: Oct. 9, 2001

Related U.S. Application Data
(60) Provisional application No. 60/243,253, filed on Oct. 25, 2000.

(51) Int. Cl. H04L 1/22

(52) U.S. Cl. 714/1; 707/1; 707/104.1

(57) ABSTRACT

A search engine system (110) includes an associative memory (112). A first search engine (114) is connected to the associative memory (112) and has first data input (116). A second search engine (118) is connected to the associative memory (112) and has a second data input (120). The search engine system may include a proximity search engine connected to the first search engine.

### RELATED APPLICATIONS

The patent application claims priority on the provisional patent application entitled “Neoslider Packet Search Engine with Optional Pre-Parser and Optional Proximity Search Engine” filed on Oct. 25, 2000.

### FIELD OF THE INVENTION

The present invention relates generally to the field of computers and more particularly to a search engine system and method.

### BACKGROUND OF THE INVENTION

It is commonly required in computers to find a particular string of data. For instance, a user might want to identify all of his documents that have a particular word. The computer creates a window the size of the word and starts searching all the files on the computer's hard disk for the word. Another example is firewalls and anti-virus programs. Unfortunately, the user might be looking for several words in several different data streams or two or more words within a certain distance (proximity) of each other. Prior art systems would require multiple search engines to analyze several different data streams. Proximity searches are commonly very processor intensive

Thus there exists a need for an improved search engine and method.

### BRIEF DESCRIPTION OF THE DRAWINGS

FIG. 1 is a schematic diagram of a sliding window search routine in accordance with one embodiment of the invention;

FIGS. 2 & 3 are a flowchart of the steps used in performing a sliding window search in accordance with one embodiment of the invention;

FIGS. 4 & 5 are a flowchart of the steps used in performing a sliding window search in accordance with another embodiment of the invention;

FIG. 6 is a flowchart of the steps used in performing a sliding window search in accordance with another embodiment of the invention;

FIG. 7 is a block diagram of a search engine system in accordance with one embodiment of the invention;

FIG. 8 is a block diagram of a search engine system in accordance with one embodiment of the invention;

FIG. 9 is a block diagram of a search engine system in accordance with one embodiment of the invention;

FIG. 10 is a schematic diagram of an associative memory in accordance with one embodiment of the invention;

FIG. 11 is a schematic diagram of a key list in accordance with one embodiment of the invention;

FIG. 12 is a schematic diagram of a mapping table and state machine in accordance with one embodiment of the invention;

FIG. 13 is a flow chart of a method of operating a search engine in accordance with one embodiment of the invention;

FIG. 14 is a flowchart of the steps used in an icon shift function in accordance with one embodiment of the invention;

FIG. 15 is a flowchart of the steps used in an icon unshift function in accordance with one embodiment of the invention;

FIG. 16 is a flowchart of the steps used in a transform function in accordance with one embodiment of the invention;

FIG. 17 is a flowchart of the steps used in an untransform function in accordance with one embodiment of the invention;

FIG. 18 is an example of a transform lookup table; and

FIG. 19 is an example of a transform translation table.

### DETAILED DESCRIPTION OF THE DRAWINGS

The present invention significantly reduces the amount of processing required to perform a search for a specific data string(s) in a block of data. This type of search is required in numerous computer applications. The sliding window search of the present invention is applicable to all of these computer applications. A search engine system includes an associative memory. A first search engine is connected to the associative memory and has a first data input. A second search engine is connected to the associative memory and has a second data input.

In one embodiment, the system has multiple search engines all connected to a single associative memory. This allows the system to easily monitor a number data streams or network sessions. When the search engine is implemented in software multiple search engines may be instantiated at the same time. The different search engines may be handled by polling methods or by placing them on separate operating threads.

In another embodiment, the system includes a pre-parser. The pre-parser enables mapping any character to any character. In addition, the pre-parser can map various white space characters to a common white space character and multiple white space characters can be removed.

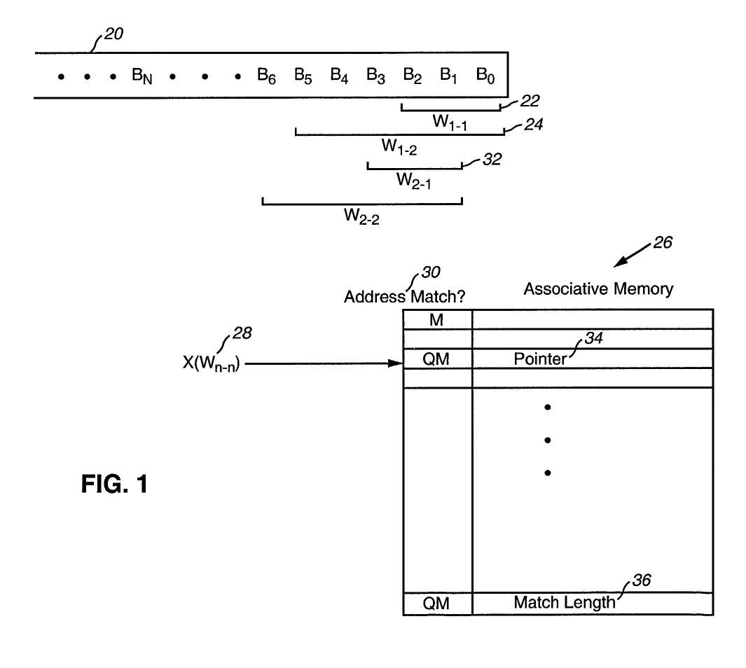

In one embodiment, a proximity engine is added to the system. The proximity system allows searches such as find “fire” and “smoke” within 100 characters (words) of each other. By combining these features with the underlying sliding window search engine describe in FIGS. 1-6 an extremely powerful and versatile search engine is created.

FIG. 1 is a schematic diagram of a sliding window search routine in accordance with one embodiment of the invention. A data block 20 to be searched is represented as B₀, B₁, B₂-Bₙ, where B₀ may represent a byte of data. A first window 22 (W₁₋₁) has a search window size of three bytes. The search window size, in one embodiment, is equal to the size of one of the plurality of data strings for which we are searching. Another window 24 (W₂₋₁) has a search window size of five bytes. An associative database (associative memory) 26 consists of a plurality of address {X(Wₙ₋ₙ)} 28. In one embodiment, the transform of each of the plurality of data strings corresponds to one of the addresses 28 of the associative memory 26. In another embodiment, a transform for at least a first portion of each of the plurality of data strings corresponds to one of the addresses 28 of the associative memory 26. In one embodiment, the transform is a cyclical redundancy code for the plurality of data strings or first portion of the plurality of data strings. In another embodiment, the transform is any linear feedback shift register transformation (polynomial code) of the data string. Generally the polynomial code is selected to have as few collisions as possible.

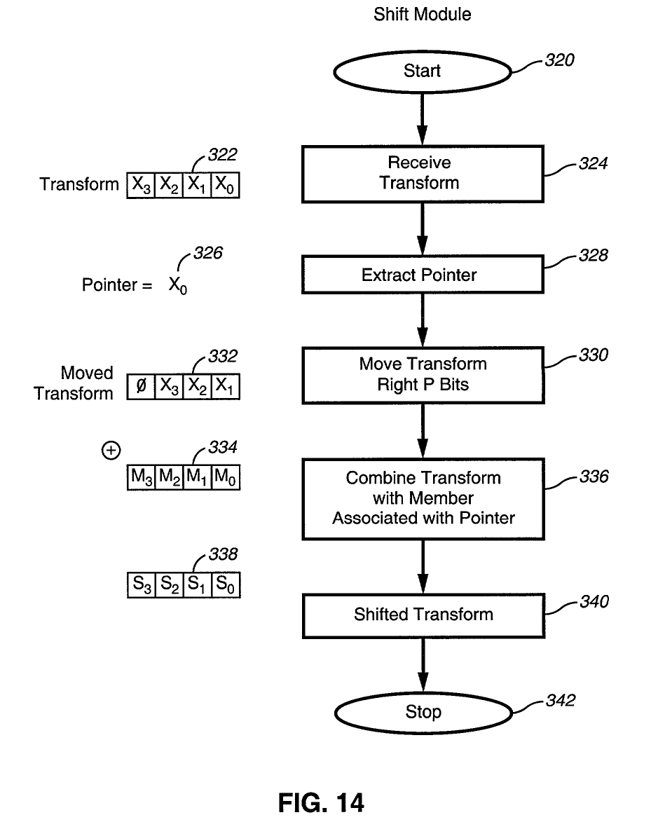

In one embodiment, a transform (icon) is determined for the first window 22 {X(W₁₋₁)}. Then the address 28 in the associative database equal to the first window transform is queried. The first entry at the address is a match indicator 30. There are three possible states for the match: no match, match (M) and qualified match (QM). When a match occurs this information is passed to a user (operating system or proximity search engine) for further processing. When a no match state is found the window slides by one byte for example. This is shown as window W₂₋₁ 32. The subscript one means its the first size window (three byte size) and the subscript two means its the second window. Note the window has slid one byte to cover bytes B₁, B₂, B₃. Prior art techniques, such as hashing, would require determining a completely new transform for the bytes B₁, B₂, B₃. The present invention however uses advanced transform techniques for linear feedback shift registers that are explained in the patent entitled “Method and Apparatus for Generating a Transform”; U.S. Pat. No. 5,942,002; assigned to the same assignee as the present application and incorporated herein by reference. These advanced transform techniques are also explained in detail with respect to FIGS. 14-19. Using these advanced techniques a transform (first byte icon) is calculated for a first byte of data (B₀). An icon shift function is performed on the first byte icon to form a shifted first byte icon. Note the shifted first byte icon is X(B₀0 0) in this case, where 0 0 represents two bytes of zeros. Note that this discussion also assumes that B₀ is the highest order byte.

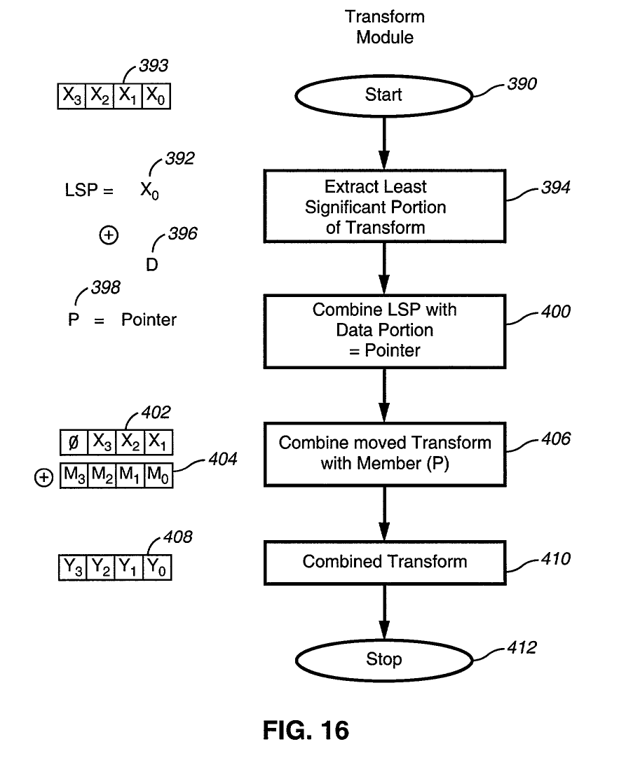

The shifted first byte icon X(B₀0 0) is exclusive ORed with the first icon X(B₀ B₁ B₂) to form a seed icon X(B₁ B₂). Next a second icon X(B₁ B₂ B₃) is formed by transforming a new byte of data (B₃) onto the seed icon X(B₁ B₂). The process of transforming a new byte of data onto an existing transform is explained with respect to FIG. 16. In another embodiment, the seed icon is icon shifted to form a shifted seed icon X(B₁ B₂ 0). The shifted seed icon X(B₁ B₂ 0) is exclusive ORed with the icon for the new byte of data X(B₃) to form the second icon X(B₁ B₂ B₃). Now the second icon represents an address in the associative memory, so we can determine if there is a match for the data (B₁ B₂ B₃). This process then repeats for each new byte of data.

Using this process significantly reduces the processing time required to determine a match. Note that if the process is searching for several three bytes strings it requires the same number of steps as searching for a single three byte string of data. This is because each new data string just represents a different entry in the associative database 26. Whereas, a standard compare functions would have to perform a comparison for each data string being searched. Thus this invention is particularly helpful where numerous data strings need to be matched.

Often the data strings for which we are searching have different lengths. In one embodiment this is handled by defining a separate window search size (e.g., W₂₋₁ 24). The two or more window sizes operate completely independently as described above. In another embodiment, the associative database 26 contains a qualified match for a first portion of each the data strings that are longer than the window length. Note, in this case the window length (window size) is selected to be equal to the shortest data string being searched. When the process encounters a qualified match, two alternative implementations are possible. In one implementation, there is a pointer 34 associated with the qualified match. The pointer points to a second icon. The process determines an icon for a next window of data. When the icon for the next window of data matches the second icon a match has been found. Note that this technique can be extended for data strings that have sizes that are many times longer than the window size. However, this implementation is limited to data sizes that are multiples of the window size. This may be limiting in some situations. The second implementation has a match length 36 associated with the qualified match. The match length indicates the total length of the data string to be matched. Then an icon can be determined for the complete data string or for just that portion of the data string that does not have an icon. Using this icon the process can determine if there is match. Using these methods it is possible to handle searches for data strings having varying lengths. This method provides a significant improvement over comparison search techniques that have to perform multiple comparisons on the same data when differing window lengths are involved.

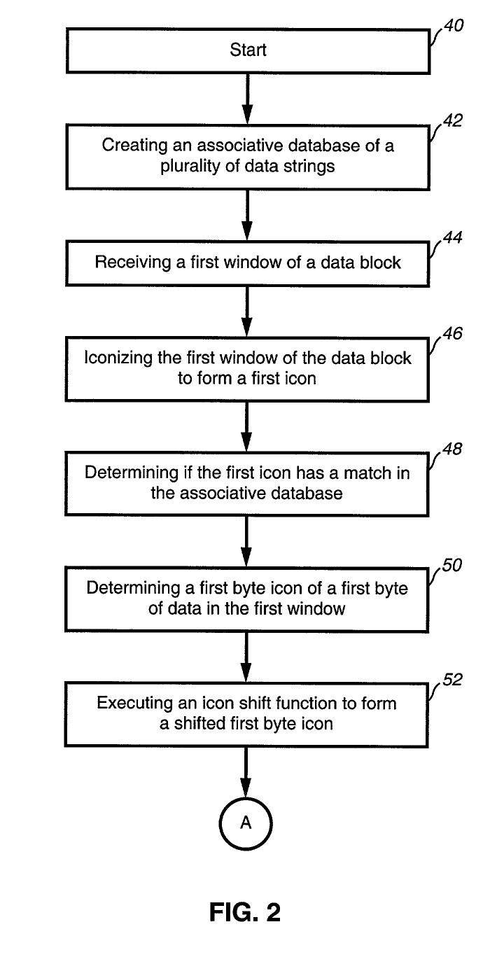

FIGS. 2 & 3 are a flowchart of the steps used in performing a sliding window search in accordance with one embodiment of the invention. The process starts, step 40, by creating an associative database of a plurality of data strings at step 42. A first window of a data block is received at step 44. The first window of the data block is iconized to form a first icon at step 46. Next it is determined if the first icon has a match in the associative database at step 48. A first byte icon is determined for the a first byte of data in the first window at step 50. An icon shift function is executed to form a shifted first byte icon at step 52. The shifted first byte icon is exclusive ORed with the first icon to form a seed icon at step 54. A second icon is determined for a second window using the seed icon and transforming a new byte of data onto the seed icon at step 56. At step 58 it is determined if the second icon has a match in the associative database which ends the process at step 60. The process just repeats until the whole block of data has been analyzed for matches. Note the process described above assumes that second window has been shifted one byte from the first window. It will be apparent to those skilled in the art the process can be easily modified to work for shifts of one bit to many bytes. The process described above also assumes that the window is larger than a single byte. However, the process would work for a single byte.

In another embodiment, the process first determines if a single search window size is required. When only a single window search size is required an icon is determined for each of the plurality of data strings. When more than a single window search size is required, a minimum length search window is determined. Next an icon is calculated for each of a first plurality of data strings having a length equal to the minimum length, to form a plurality of first icons. The plurality of first icons are stored in the associative database. Next an icon is calculated for a first portion of each of a plurality of data strings, to form a plurality of second icons. The plurality of second icons are stored in the associative database. An icon is calculated for a second portion of each of the second plurality of data strings to form a plurality of third icons. The plurality of third icons are stored in the associative database. A pointer is stored with each of the second icons that points to the one of the plurality of third icons. Note that in one embodiment a match flag is stored at an address corresponding to the icons (first icons, second icons, third icons).

In another embodiment, when the process finds that the first icon is found in the associative database, it is determined if a pointer is stored with the first icon. When a pointer is not stored with the first icon, then a match has been found. When a pointer is stored with the first icon a next icon is determined. The next icon is the transform for the next non-overlapping window of the data block being searched. The next icon is compared to the icon at the pointer location. When the next icon is the same as the icon at the pointer location a match has been found.

In another embodiment when the first icon is found in the associative database and includes a pointer, a second icon is determined. Next it is determined if the second icon has a match in the associative database. In another embodiment the second icon is determined using an icon append operation with a second portion to the first icon. The second portion is the next non-overlapping window of data in the data block being searched.

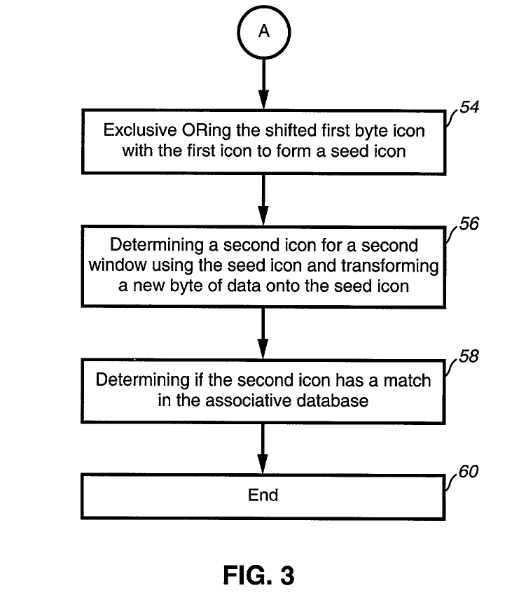

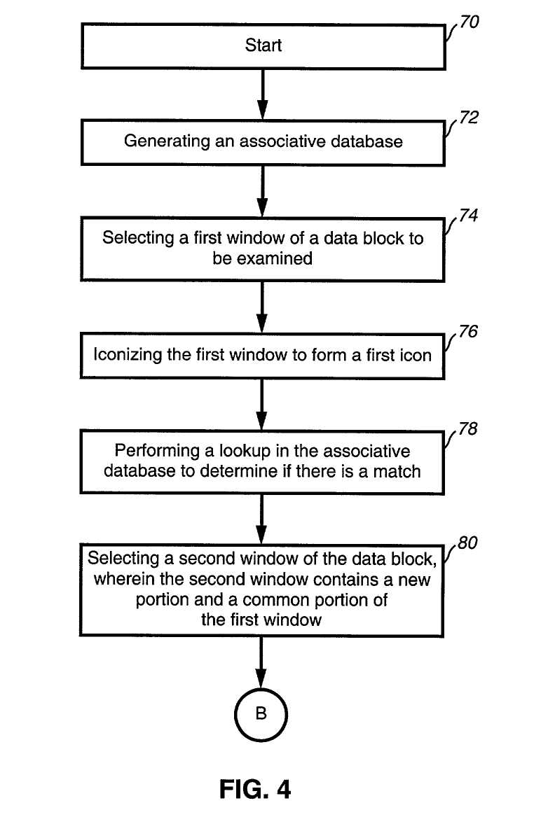

FIGS. 4 & 5 are a flowchart of the steps used in performing a sliding window search in accordance with another embodiment of the invention. The process starts, step 70, by generating an associative database at step 72. A first window of a data block is selected to be examined at step 74. The first window is iconized to form a first icon at step 76. A lookup in the associative database is performed to determine if there is a match at step 78. A second window of the data block is selected, wherein the second window contains a new portion and a common portion of the first window at step 80. A second icon is determined using the first icon, a discarded portion and the new portion but not the common portion at step 82. The second icon is associated with the second window, which ends the process at step 84. In one embodiment, this process is repeated until the complete data block has been examined. In another embodiment the process of forming an icon involves a linear feedback shift register operation. In another embodiment the linear feedback shift register operation is a cyclical redundancy code.

In another embodiment the process of forming the second icon includes determining a discarded icon for the discarded portion. Then an icon shift function is executed to form a shifted discarded icon. The shifted discarded icon is exclusive ORed with the first icon to form a seed icon. A new icon is determined for the new potion. The new icon is exclusive ORed with the seed icon to form the second icon.

In another embodiment the lookup process determines if there is a match including determining if the associative database indicates a match, a no match or a qualifier match. When a qualifier match is indicated, a next window icon for the next complete non-overlapping window of data is determined. Then it is determined if there is a pointer pointing from the first icon to the next window icon.

In another embodiment, when a qualifier match is indicated, a match length is determined. An extra portion is appended onto the first icon to form a second icon. Note the extra portion of the data plus the window of data that has been iconized is equal to the match length. Using the second icon it is determine if the associative database indicates a match.

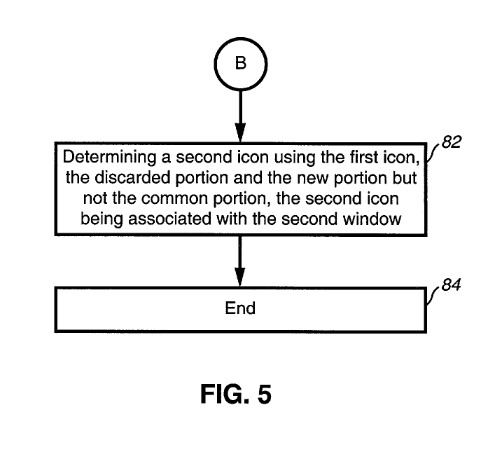

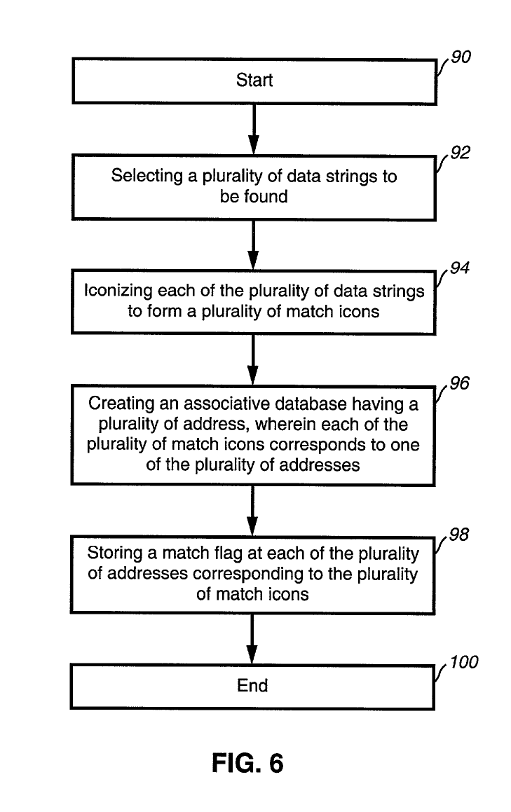

FIG. 6 is a flow chart of the steps used in performing a sliding window search in accordance with another embodiment of the invention. The process starts, step 90, by selecting a plurality of data strings to be found at step 92. The plurality of data strings are iconized to form a plurality of match icons at step 94. An associative database is created having a plurality of icons, wherein each of the match icons corresponds to one of the plurality of addresses at step 96. At step 98, a match flag is stored at each of the plurality of addresses corresponding to the plurality of match icons which ends the process at step 100. When the plurality of data strings do not all have a same length a plurality of shortest data strings are selected. A plurality of short icons associated with the shortest data strings are determined. The match indicator is stored in the associative database at the address associated with each of the short icons. A plurality of qualifier icons are determined for a first portion of a plurality of longer data strings. A qualifier flag is stored in the associative database for each of the qualifier icons. A match length indicator is stored with each of the qualifier icons in the associative database. An icon is determined for a first window of a data block, wherein the first window has a window length equal to a shortest length. A lookup is performed in the associative database to determine if there is a match flag or a qualifier flag. When there is a qualifier flag, the match length indicator is retrieved. A complete icon is determined for the portion of the data block equal to the match length. A lookup is performed to determine if there is a match flag associated with the complete icon.

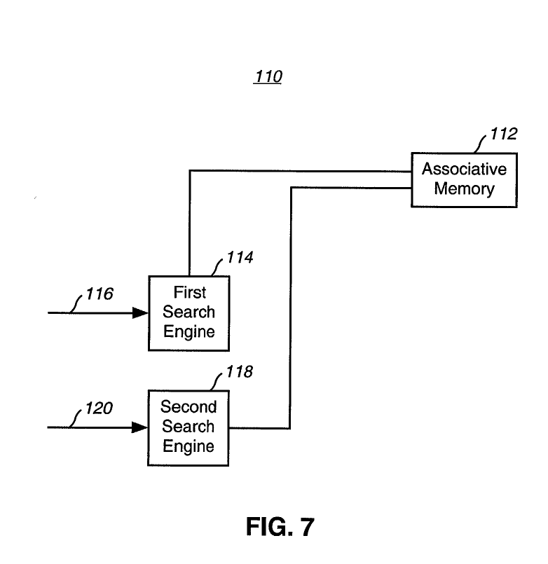

FIG. 7 is a system diagram of a search engine system 110 in accordance with one embodiment of the invention. The system 110 includes an associative memory 112. A search engine 114 is connected to the associative memory 112 and includes a first data input 116. A second search engine 118 is connected to the associative memory 112 and includes a second data input 120. In one embodiment, the first search engine 114 is connected to a packet input queue. The input of the packet input queue is connected to a data stream. The packet input queue strips the header data from the data stream packets to form a raw data stream. A message may be broken into several data stream packets as a result the beginning of the message is determined. A flag is set on the raw data input packet designating the beginning of a message. When the end of the message is encountered a flag is set to indicate that this is the end of the message. If the message is very short the raw data input packet will include both a start and end of message flag. The search engine 114 in one embodiment performs a search of the raw data packets described with respect to FIGS. 1-6. The associative memory in one embodiment is the associative memory described in the United States Patent Application entitled “Memory Management System and Method”, having Ser. No. 09/419,217, filed on Oct. 15, 1999, having the same assignee as the present application and herein incorporated by reference. The associative memory 112 stores character strings (words) that are being searched for by the system 110. As will be apparent to those skilled in the art, numerous sliding search engines may be connected to a single associative memory.

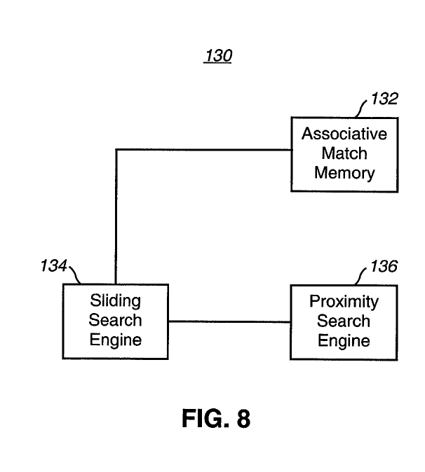

FIG. 8 is a system diagram of a search engine system 130 in accordance with one embodiment of the invention. The system 130 includes an associative match memory 132. A sliding search engine 134 is connected to the associative match memory 132. The sliding search engine 134 has an output connected to a proximity search engine 136. This embodiment of the invention allows the proximity search engine 136 to located two or more words with a certain distance of each other.

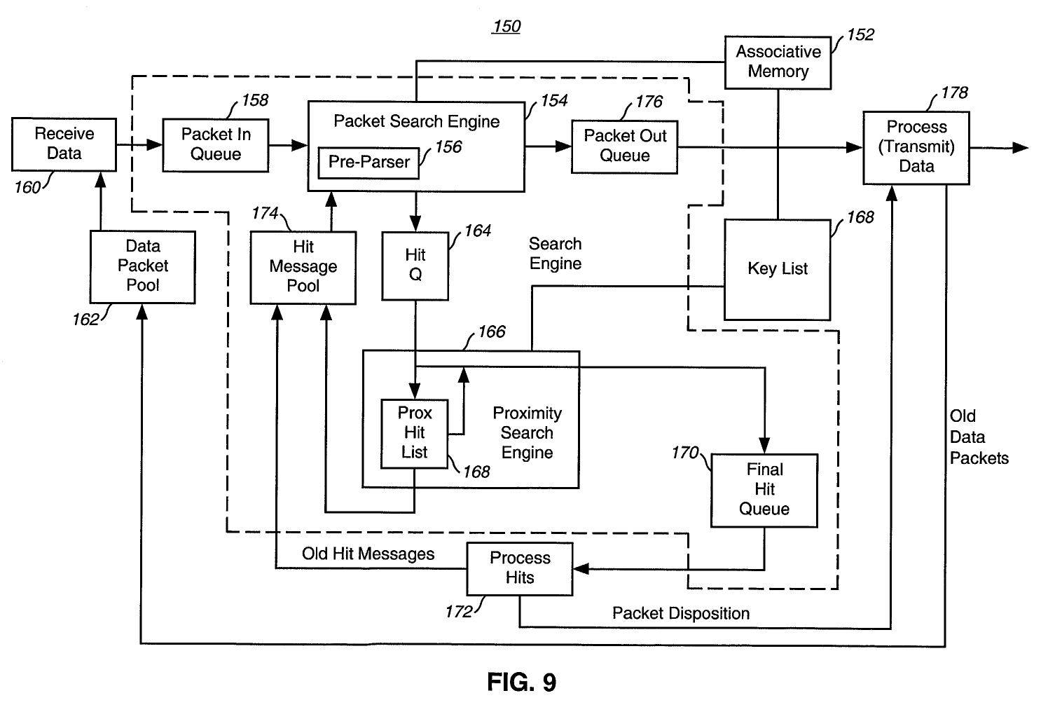

FIG. 9 is a block diagram of a search engine system 150 in accordance with one embodiment of the invention. The system 150 includes an associative memory 152. The associative memory 152 is connected to a packet search engine 154. In one embodiment the packet search engine 154 includes a pre-parser 156. The pre-parser 156 is used to convert characters to other characters. For instances, all capital letters might be converted to lower case letters. This will simplify the search process. Another example of how the pre-parser might be used is to convert all white space characters to a single space character and remove any duplicate white space characters. To explain how this works assume we are searching for “John Smith” in a stream of data. The problem is that “John” could be at the end of one line and “Smith” could be at the beginning of the next line. There will be a line-feed, carriage return, and possibly multiple spaces between “John” and “Smith”: “John<CR><LF><NonPrintableChars><Sp><Sp>Smith”. This character string will be mapped to “John<Sp>Smith”. This makes it easier to find the character string “John Smith”.

A packet input queue 158 is connected to the packet search engine 154 and contains packets of raw data to be searched. A receive data block 160 is connected to the packet input queue. The receive data block 160 strips out any overhead information from the incoming data stream packets of data and determines beginning and end points for a message. The data packet pool 162 contains empty packets waiting to be filled with data and is mainly a memory allocation technique.

When the packet search engine 154 has a hit (i.e., found a character string being searched for and stored in the associative memory), the item that was found is placed in a hit queue 164. In addition, to the item an offset may be stored with the item. The offset may be in the number of characters since the beginning of a message and may include a message number. This allows the item to be found again in the text vary easily. The item is passed from the hit queue 164 to the proximity search engine 166. The proximity search engine 166 queries a key list 168 to determine if the item is part of a proximity search. For example, assume the item found is “fire”. It may be that the user is only interested in “fire” if it is within a certain distance (characters, words) of “smoke”. The key list would then show “fire [100] smoke” which means find fire within 100 characters of smoke. When this is the case the word “fire” is stored in the proximity hit list 168. Associated with the word “fire” will be a proximity offset. For instance, if the end of the word “fire” is character 203 the proximity offset would be 303. Assume we find the word “smoke” at an offset of 350. Then the word fire is purged from the proximity hit list, since it was not within 100 characters of “smoke”. The word “smoke” is not stored in the proximity hit list, since it is a second item without being within the required distance of the first item. Assume instead we find the word “smoke” at an offset of 250, the words “fire”, “smoke” and maybe an offset are sent to the final hit queue 170. Unless we are not looking for three words within a certain distance of each other. Note that it is possible to set up the proximity hit queue 168 without storing the item (e.g., “fire”). In addition, the offset stored with items found will depend on the application. The proximity search engine 166 and key list 168 are designed to look for words in a predetermined order, however they may be easily modified to search for words without order. In other words we could specify “fire” within 100 characters of “smoke” to mean find either “fire” or “smoke” first and then look for “smoke” or “fire” within 100 characters. In another case we may only be interested in the “fire” by itself. In which case the item is immediately passed to the final hit queue 170.

From the final hit queue 170 hits are sent to a process hits block 172. The processing of the hits will vary from application to application. For instance a firewall may just kill a message, while a text search may want to highlight the items found. The process hits block 172 is connected to a hit message pool 174. The hit message pool 174 is simply a memory management technique to store memory for new hits.

When a hit is not found the output is sent to a packet output queue 176. The output packet queue 176 is connected to a process or transmit data block 178. If no hits require processing the data may be forwarded to its destination. Note that in one embodiment the complete search engine system is implemented in software. In another embodiment, some or all of the search engine is implemented in hardware.

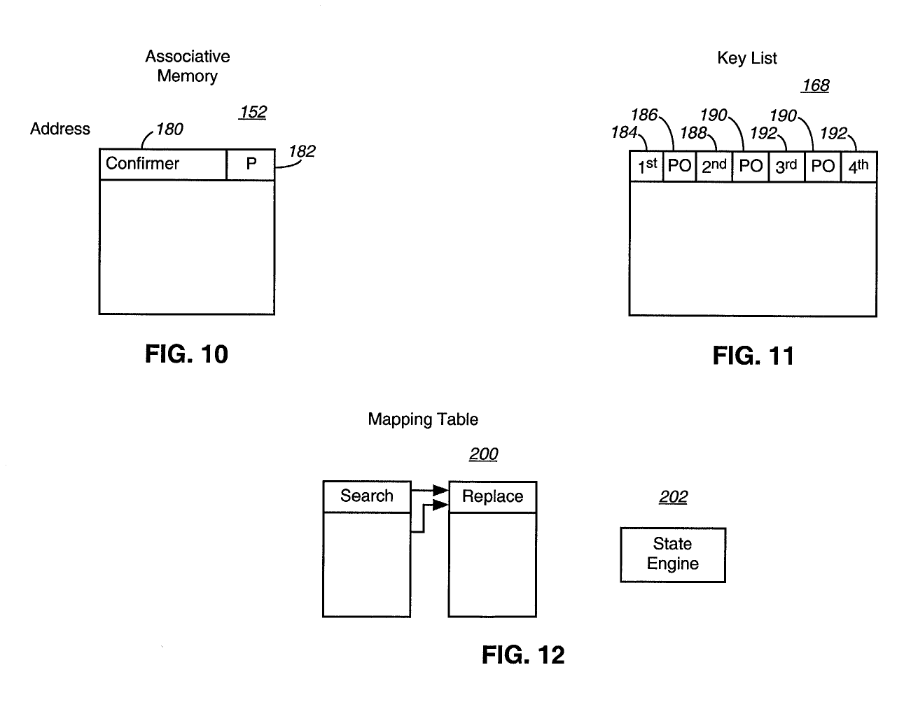

FIG. 10 is a schematic diagram of an associative memory 152 in accordance with one embodiment of the invention. The associative memory 152 in one embodiment contains a confirmer 180 for every location containing a hit. In an associative memory, as described in the United States Patent Application entitled “Memory Management System and Method”, having Ser. No. 09/419,217, filed on Oct. 15, 1999, having the same assignee as the present application and herein incorporated by reference, the confirmer is part of the hashing code (transform). A part of the hashing code is used to determine the address for the item and a second part is stored in the address as a confirmer. The confirmer is part of the process of handling collisions in the associative memory. Each address storing an item, will also include a pointer 182 to where the item is stored in the key list 168. An address may contain additional information.

FIG. 11 is a schematic diagram of a key list 168 in accordance with one embodiment of the invention. The key list 168 contains a first item 184 to be found and a proximity offset 186 to the second item to be found 188. If additional items are to be found, the location will include additional proximity offsets 190 and additional items 192. Note if the user is interested in the item by itself there will be no proximity offset 186 and there may be a flag indicating that only one item is to be found.

FIG. 12 is a schematic diagram of a mapping table 200 and state machine 202 in accordance with one embodiment of the invention. The mapping table 200 is used by the pre-parser and contains a one-to-one mapping of characters. For instance “A” may be mapped to “a”. In general all capital letters may be mapped to lower case letters or vice versa. This simplifies the search process for the search engine. The mapping table may map all white space characters to a common white space character. Once all the characters have been mapped a state engine 202 looks for multiple white space characters and converts them to a single white space character. This also simplifies the search process and improves its accuracy. Note multiple strings of words to be found in proximity to each other may be stored in the key list 168.

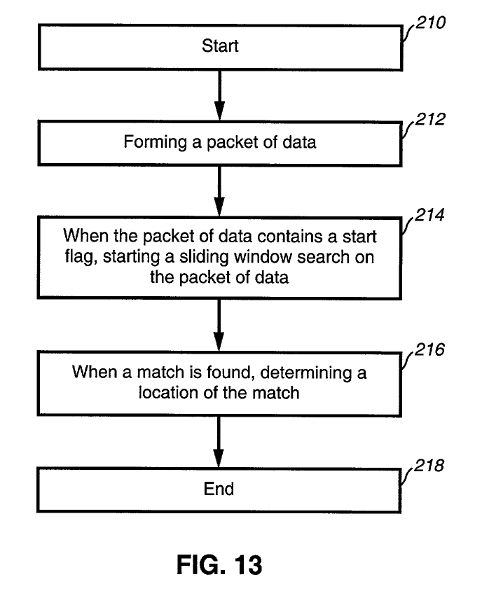

FIG. 13 is a flow chart of a method of operating a search engine in accordance with one embodiment of the invention. The process starts, step 210, by forming a packet of data step 212. When the packet of data contains a start flag, a sliding window search on the packet of data is started at step 214. When a match is found at step 216, a location of the match is determined which ends the process at step 218. The location is usually stated in number of characters (words) from the start of a message identified by the start flag. In one embodiment, the raw data is parsed to find a predetermined set of characters. When the predetermined set of characters is found they are replaced with a replacement set of characters. In one embodiment the predetermined set of characters is any combination of white space characters and the replacement set of characters is a space character. In another embodiment the predetermined set of characters is a capital letter and the replacement set of characters is a lower case letter.

In one embodiment, it is determined if the match is contained in a proximity key list. When the match is contained in a proximity key list, it is determined if the match is a primary index. When the match is a primary index (184), the match is stored in the proximity hit queue. When the match is a next index (188), the proximity hit queue is searched for an associated primary index. The proximity hit queue is searched by determining if the first entry is the associated primary index. When the first entry is the associated primary index a distance between the next index and the primary index is determined. When the distance is less than a proximity offset a proximity hit is stored in the final proximity hit queue. When the distance is greater than a proximity offset, the associated primary index is purged from the proximity hit queue. When the first entry is not the associated primary index, it is determined if the offset into the message is greater than the maximum offset for the first entry. When the offset into the message is greater than the maximum offset for the first entry, the first entry is purged.

In one embodiment the process receives an input data stream. The overhead data is removed to form a raw data stream. A start of a message is determined. Note that a message is a coherent set of data. In a packet data system a message may be broken up into several packets. Thus the system determines the start of a message. A search packet is formed containing a start flag and a portion of the raw data. Next a plurality search packets are formed containing only the raw data. An end of message is determined. When an end of message is found, a final search packet having an end flag is formed.

Thus there has been described an improved search engine system that may monitor multiple streams of data and have only a single hit memory. In addition, the system may include a pre-parser to map characters to other characters. This can improve search results and simplify the search query. In addition, the system may contain a proximity search engine to find a pair or group of words within a certain distance of each other.

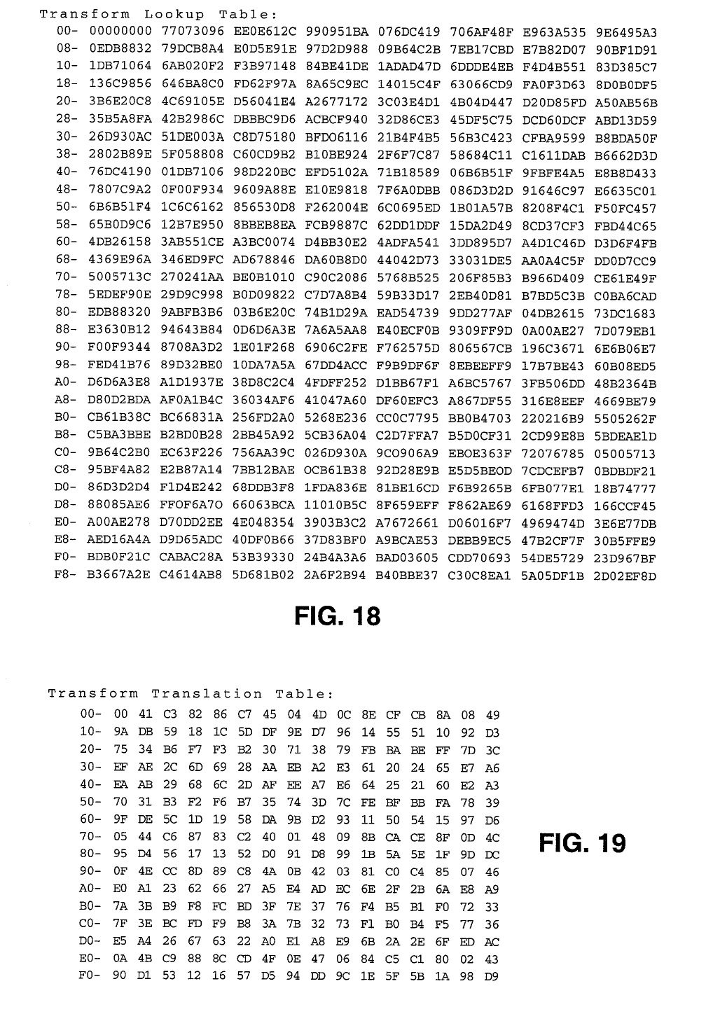

The following figures explain the “icon algebra” used in implementing the invention. FIG. 14 is a flow chart of the steps used in an icon shift function in accordance with one embodiment of the invention. The shift module determines the transform for a shifted message (i.e., “A0” or X^{Z}A(x)). Where X^{Z} means the function is shifted by z places (zeros) and A(x) is a polynomial function. The process starts, step 320, by receiving the transform 322 to be shifted at step 324. Next the a pointer 326 is extracted at step 328. The transform 322 is then moved right by the number of bits in the pointer 326, at step 330. This forms a moved transform 332. Note the words right and left are used for convenience and are based on the convention that the most significant bits are placed on the left. When a different convention is used, it is necessary to change the words right and left to fit the convention. Next the moved transform 332 is combined (i.e., XOR'ed) with a member 334 associated with the pointer 326, at step 336. The member associated with the pointer is found in a transform lookup table, like the one shown in FIG. 18. Note that this particular lookup table is for a CRC-32 polynomial code, however other polynomial codes can be used and they would have different lookup tables. This forms the shifted transform 338 at step 340, which ends the process at step 342. Note that if the reason for shifting a first transform is to generate a first-second transform then the first transform must be shifted by the number of bits in a second data string. This is done by executing the shift module X times, where X is equal to the number of data bits in the second data string divided by the number of bits in the pointer. Note that another way to implement the shift module is to use a polynomial generator. The first transform 322 is placed in the intermediate remainder register. Next a number of logical zeros (nulls) equal to the number of data bits in second data string are processed.

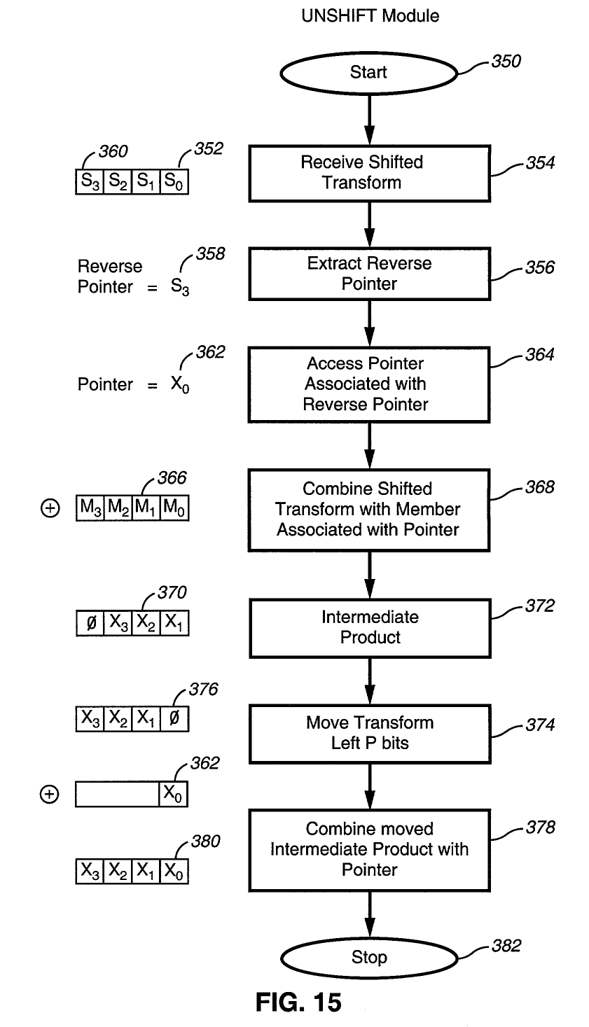

FIG. 15 is a flow chart of the steps used in an icon unshift function in accordance with one embodiment of the invention. An example of when this module is used is when the transform for the data string “AB” is combined with the transform for the data string “B”. This leaves the transform for the data string “A0” or X^{Z}A(x). It is necessary to “unshift” the transform to find the transform for the data string “A”. The process starts, step 350, by receiving the shifted transform 352, at step 354. At step 356 a reverse pointer 138 is extracted. The reverse pointer 358 is equal to the most significant portion 360 of the shifted transform 352. The reverse pointer 358 is associated with a pointer 362 in the reverse look up table (e.g., see FIG. 19) at step 364. Next, the member 366 associated with the pointer 362 in the table of FIG. 18 for example, is combined with the shifted transform at step 368. This produces an intermediate product 370, at step 372. At step 374 the intermediate product 370 is moved left to form a moved intermediate product 376. The moved intermediate product 376 is then combined with the pointer 362, at step 378, to form the transform 380, which ends the process, step 382. Note that if the number of bits in the “B” data string (z) is not equal to the number of bits in the pointer then the unshift module is executed X times, where X=z/(number of bits in pointer).

FIG. 16 is a flow chart of the steps used in a transform function in accordance with one embodiment of the invention. The transform module can determine the first-second transform for a first-second data string given the first transform and the second data string, without first converting the second data string to a second transform. The process starts, step 390, by extracting a least significant portion 392 of the first transform 393 at step 394. This is combined with the second data string 396 to form a pointer 398, at step 400. Next a moved first transform 402 is combined with a member 404 associated with the pointer in the look up table (e.g., FIG. 18), at step 406. A combined transform 408 is created at step 410, which ends the process, step 412. Note that if the pointer is one byte long then the transform module can only process one byte of data at a time. When the second data string is longer than one byte then the transform module is executed one data byte at a time until all the second data string has been executed. In another example assume that first transform is equal to all zeros (nulls), then the combined transform is just the transform for the second data string. In another embodiment the first transform could be a precondition and the resulting transform would be a precondition-second transform. In another example, assume a fourth transform for a fourth data string is desired. A first data portion (e.g., byte) of the fourth data string is extracted. This points to a member in the look up table. When the fourth data string contains more than the first data portion, the next data portion is extracted. The next data portion is combined with the least significant portion of the member to form a pointer. The member is then moved right by the number of bits in the next data portion to form a moved member. The moved member is combined with a second member associated with the pointer. This process is repeated until all the fourth data string is processed.

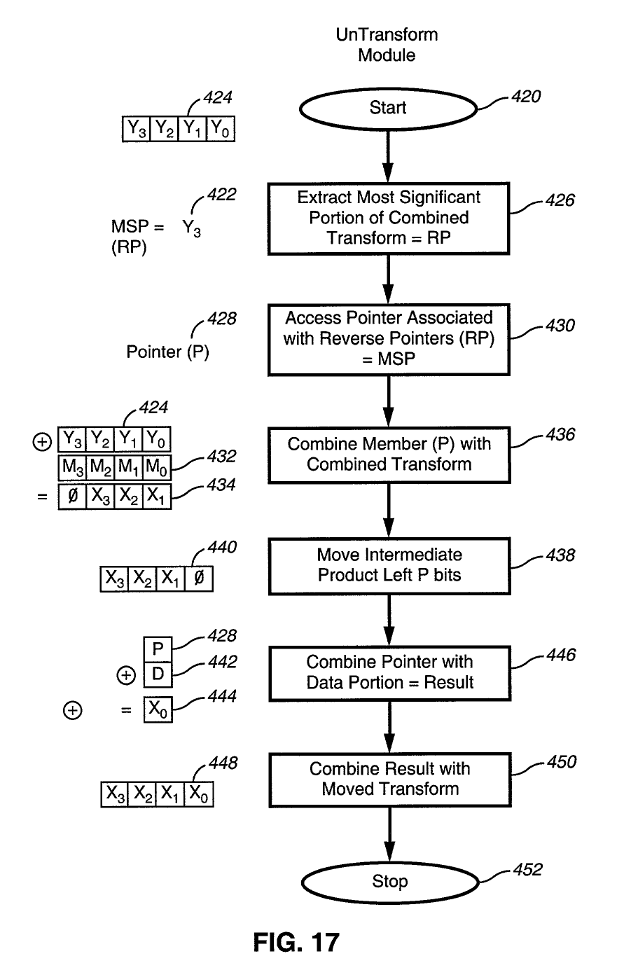

FIG. 17 is a flow chart of the steps used in an untransform function in accordance with one embodiment of the invention. The untransform module can determine the first transform for a first data string given the first-second transform and the second data string. The process starts, step 420, by extracting the most significant portion 422 of the first-second transform 424 at step 426. The most significant portion 422 is a reverse pointer that is associated with a pointer 428 in the reverse look-up table. The pointer is accessed at step 430. Next the first-second transform 424 is combined with a member 432 associated with the pointer to form an intermediate product 434 at step 436. The intermediate product is moved left by the number of bits in the pointer 428 at step 438. This forms a moved intermediate product 440. Next the pointer 428 is combined with the second data string 442 to form a result 444 at step 446. The result 444 is combined with the moved intermediate product 440 to form the first transform 448 at step 450, which ends the process at step 452. Again this module is repeated multiple times if the second data string is longer than the pointer.

Some examples of what the transform module can do, include determining a second-third transform from a first-second-third transform and a first transform. The first transform is shifted by the number of data bits in the second-third data string. The shifted first transform is combined with the first-second-third transform to form the second-third transform. In another example, the transform generator could determine a first-second-third-fourth transform after receiving a fourth data string. In one example, the transform module would first calculate the fourth transform (using the transform module). Using the shift module the first-second-third transform would be shifted by the number of data bits in the forth data string. Then the shifted first-second-third transform is combined, using the combiner, with the fourth transform.

The methods described herein can be implemented as computer-readable instructions stored on a computer-readable storage medium that when executed by a computer will perform the methods described herein.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A search engine system, comprising:
an associative memory;
a first search engine having a first data input and a connection to the associative memory; and
a second search engine having a second data input and a connection to the associative memory.

2. The search engine system of claim 1, further including a pre-parser having an input connected to the first data input and an output connected to an input of the first search engine.

3. The search engine system of claim 1, further including a hit output queue connected to the first search engine.

4. The search engine system of claim 3, further including a proximity search engine connected to an output of the first search engine.

5. The search engine system of claim 4, further including a key list connected to the proximity search engine.

6. The search engine system of claim 5, further including a proximity hit queue connected to the proximity search engine.

7. The search engine system of claim 1, wherein the first search engine includes a transform generator.

8. The search engine system of claim 7, wherein the transform generator converts an input data into an address and a confirmer.

9. The search engine system of claim 5, wherein the key list contains at least two text strings and a distance between the at least two text strings.

10. The search engine system of claim 1, further including a packet input queue connected to the associative memory.

11. A method of operating a search engine system, comprising the steps of:
a) forming a packet of data;
b) when the packet of data contains a start flag, starting a sliding window search on the packet of data;
c) when a match is found, determining a location of the match.

12. The method of claim 11, wherein step (a) further includes the step of:
a1) parsing a raw data to find a predetermined set of characters;
a2) when the predetermined set of characters is found, replacing the predetermined set of characters with a replacement set characters.

13. The method of claim 12, wherein step (a1) further includes the steps of:
i) defining the predetermined set of characters to be any combination of white space characters;
ii) defining the replacement set of characters as a space character.

14. The method of claim 12, wherein step (a1) further includes the steps of:
i) defining the predetermined set of characters to be all capital letter;
ii) defining the replacement set of characters as a corresponding lower case letter.

15. The method of claim 11, further including the steps of:
d) determining if the match is contained in a proximity key list;
e) when the match is contained in a proximity key list, determining if the match is a primary index;
f) when the match is a primary index, storing the match in the proximity hit queue.

16. The method of claim 15, further including the step of:
f) when the match is a next index, searching the proximity hit queue for an associated primary index.

17. The method of claim 16, further including the steps of:
g) determining if a first entry is the associated primary index;
h) when the first entry is the associated primary index, determining a distance between the next index and the primary index;
i) when the distance between the next index and the primary index is less than a proximity offset storing a proximity hit in the final proximity hit queue.

18. The method of claim 16, further including the steps of:
j) when the distance between the next index and the primary index is not less than the proximity offset, flushing the primary index from the proximity hit queue.

19. The method of claim 11, wherein step (a) further includes the steps of:
a1) receiving an input data stream;
a2) removing an overhead data to form a raw data stream;
a3) determining a start of a message;
a4) forming a search packet containing a start flag and a portion of the raw data;
a5) forming a plurality of search packets containing only the raw data;
a6) determining an end of the message;
a7) when an end of message is found, forming a final search packet containing an end flag.

20. A search engine system comprising:
an associative match memory;
a sliding search engine connected to the associative match memory; and
a proximity search engine connected to an output of the sliding search engine.

21. The search engine system of claim 20, further including a plurality of sliding search engines that are each connected to a separate data stream.

22. The search engine system of claim 20, further including a plurality of proximity engines are connected the sliding search engine.

23. The search engine system of claim 20, further including a pre-parser connected to one of the sliding search engine.

24. The search engine system of claim 23, wherein each of the plurality of pre-parsers contains a mapping table.

25. The search engine system of claim 24, wherein an entry in the mapping table contains a characters to be replaced location and a replacement characters location.

26. The search engine system of claim 20, further including a plurality of proximity search engines connected to the sliding search engine.

27. The search engine system of claim 26, further including a key list memory connected to the proximity search engine.

28. The search engine system of claim 27, wherein the key list contains a plurality of locations, at least one of the plurality of locations contains a primary index, a next index and a proximity offset.

29. The search engine system of claim 27, wherein the proximity search engine contains a proximity hit list.

30. The search engine system of claim 21, further including a data input processor.
